(19) United States
(12) Patent Application Publication
(10) Pub. No.: US 2025/0162428 A1
(43) Pub. Date: May 22, 2025

(54) ELECTRIC VEHICLE POWERTRAIN CONTROL ALGORITHM

(71) Applicant: Gillig LLC, Livermore, CA (US)

(72) Inventors: Michael Cody Wampler, Windsor, CO (US); Samantha Marie White, Loveland, CO (US); William Briggs, Loveland, CO (US); Keith Lehmeier, Fort Collins, CO (US); Michael Corona, Fort Collins, CO (US)

(21) Appl. No.: 18/956,153

(22) Filed: Nov. 22, 2024

Related U.S. Application Data
(60) Provisional application No. 63/602,181, filed on Nov. 22, 2023.

(51) Int. Cl. B60L 15/20

(52) U.S. Cl. CPC B60L 15/2018; B60L 2240/12; B60L 2240/423; B60L 2240/642; B60L 2250/26

(57) ABSTRACT

An electric vehicle (EV) comprises a vehicle wheel, a drive subsystem including a drive motor coupled with the vehicle wheel, and a control subsystem coupled to the drive subsystem and including a driver torque input configured to set a target propulsion torque. The control subsystem is configured to control the drive motor to apply the target propulsion torque to the vehicle wheel, determine a stalled condition of the drive subsystem during the application of the target propulsion torque, and, in response to determining the stalled condition, calculate a rollback torque, and control the drive motor to cancel the application of the target propulsion torque and to apply the rollback torque to the vehicle wheel, the rollback torque configured to allow the EV to travel down an incline at a rollback speed. The rollback torque comprises a lower torque value than a torque value of the target propulsion torque.

### CROSS-REFERENCE TO RELATED APPLICATIONS

The present invention claims the benefit to and priority of U.S. Provisional Application No. 63/602,181, filed Nov. 22, 2023. The entire disclosure of the above application is incorporated herein by reference.

### TECHNICAL FIELD

The technology disclosed herein relates generally to electric vehicles and control algorithms for monitoring and managing powertrain operations thereof.

### BACKGROUND

While stationary on a hill or other incline, electric vehicle (EV) controllers may utilize control algorithms to stall powertrain and motor operations to prevent the EV from rolling backwards unintentionally in the absence of any engagement with a braking system. For example, the driver may change foot positioning to disengage the brake in favor of engaging the accelerator to begin driving up the hill. Existing algorithms related to low-speed powertrain operations include hill hold and hill start assist functions. Hill hold and hill start assist functions prevent stationary EVs from rolling in the opposite direction of the intended motion. In this manner, uncontrolled rollback during the period between disengagement with the brake pedal and engagement with the accelerator pedal can be reduced or eliminated. The hill hold and hill start assist functions intentionally induce a stalled condition in the inverters and motors coupled to the wheels. Problematically, EVs that automatically employ such functions (while the motor is stalled) can deplete the battery and deceive the driver into thinking that the EV is secured, when instead, the powertrain is no longer able to provide the necessary torque to prevent uncontrolled rollback.

Extended periods of motor stall can cause the power train to fail. During a motor stall, a three-phase inverter coupled to the motor experiences current flow through only one or a pair of phases. In a condition where heavy current is flowing through the single phase or set of phases in order to keep the motor (together with its attached wheel) stationary can put stresses on the inverter sufficient to cause the inverter to shut down, thus removing all controlling energy supplied to the motor to induce torque in the wheel. As a result, an uncontrolled rollback of the EV can occur. Such extended motor stalling can occur via the hill hold and hill start assist functions described above as well as during conditions where the speed of the EV falls to zero while driving up hills due to the incline of the hill and the lack of powertrain power to overcome countering forces.

### SUMMARY

Disclosed herein are improvements to electric vehicle (EV) powertrain control algorithms, and more particularly, to algorithms for controlling the torque produced by the EV.

In accordance with one aspect of the present disclosure, an electric vehicle (EV) comprises a vehicle wheel, a drive subsystem including a drive motor coupled with the vehicle wheel, and a control subsystem coupled to the drive subsystem and including a driver torque input configured to set a target propulsion torque. The control subsystem is configured to control the drive motor to apply the target propulsion torque to the vehicle wheel, determine a stalled condition of the drive subsystem during the application of the target propulsion torque, and, in response to determining the stalled condition, calculate a rollback torque, and control the drive motor to cancel the application of the target propulsion torque and to apply the rollback torque to the vehicle wheel, the rollback torque configured to allow the EV to travel down an incline at a rollback speed. The rollback torque comprises a lower torque value than a torque value of the target propulsion torque.

In accordance with another aspect of the present disclosure, a method of propelling an electric vehicle (EV) including a driving wheel, a drive subsystem comprising a drive motor, and a control subsystem. The method comprises applying a driving torque in a first rotational direction to the driving wheel via the drive motor sufficient to cause the EV to travel in a drive direction in response to a propulsion input, sensing a stalled condition in the drive motor, calculating a rollback torque having a torque value lower than a torque value of the driving torque, and, subsequent to sensing the stalled condition, ceasing application of the driving torque, and applying the rollback torque in the first rotational direction to the driving wheel via the drive motor sufficient to cause the EV to travel in a rollback direction opposite to the drive direction.

In accordance with yet another aspect of the present disclosure, a computing apparatus comprises one or more computer-readable storage media and program instructions stored on the one or more computer-readable storage media executable by a processing device to direct the processing device to detect a stalled state in a drive motor coupled to a drive wheel of an electric vehicle (EV), the drive motor applying a driving torque to the drive wheel. The processing device is further directed to remove application of the driving torque to the drive wheel in response to detecting the stalled state, calculate a rollback torque having a torque value lower than a torque value of the driving torque, and apply the rollback torque to the drive wheel in a first rotational direction while the drive wheel rotates in a second rotational direction opposite the first rotational direction.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The drawings illustrate embodiments presently contemplated for carrying out the invention.

In the drawings:

FIG. 1 illustrates a block diagram of an EV in accordance with an embodiment.

FIG. 2 illustrates a block diagram of an EV in accordance with another embodiment.

FIG. 3 illustrates a series of steps for performing powertrain control algorithms of an electric vehicle in accordance with an embodiment.

FIG. 4 illustrates a series of steps for performing a controlled rollback control algorithm of an electric vehicle in accordance with an embodiment.

FIG. 5 illustrates an example operating environment including an electric vehicle performing a powertrain control algorithm in accordance with an embodiment.

FIG. 6 illustrates another example operating environment including an electric vehicle performing a powertrain control algorithm in accordance with an embodiment.

FIG. 7 illustrates another example operating environment including an electric vehicle performing a powertrain control algorithm in accordance with an embodiment.

FIG. 8 illustrates a plot showing a relationship between a rollback torque limit and an inclination angle in accordance with an embodiment.

FIG. 9 illustrates a plot showing a relationship between a rollback speed and an inclination angle in accordance with an embodiment.

FIG. 10 illustrates a computing system suitable for implementing the various operational environments, architectures, processes, scenarios, and sequences discussed below with respect to the other Figures.

The drawings are not necessarily drawn to scale. In the drawings, like reference numerals designate corresponding parts throughout the several views. In some embodiments, components or operations may be separated into different blocks or may be combined into a single block.

### DETAILED DESCRIPTION

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

Discussed herein are enhanced components, techniques, and systems related to powertrain control algorithms of an electric vehicle (EV). EVs often utilize a wide range of control algorithms to meet various safety and functional requirements. One example algorithm may include functions to monitor and manage powertrain operations to prevent motor stall of the EV while ascending or descending an incline during operation of the EV.

Motor stall of an EV may occur when the commanded torque from the powertrain is equal to or less than the torque of the road load, resulting in no movement from the EV. Problematically, this may lead to downstream complications in the event the motor is in a stalled state for a long enough duration. For example, if the motor is within the stalled state for too long, the inverter may overheat, resulting in a sudden loss or reduction of torque within the powertrain. Consequently, in real-world applications, such as when an EV is driving up a hill, a sudden loss in torque due to motor stall may lead to an uncontrolled rollback of the EV.

Disclosed herein is an improved control algorithm for preventing uncontrolled rollback powertrain operations. The proposed algorithm operates within the bounds of the powertrain for reducing loss of control due to a stalled condition lasting too long. Referred to as a controlled rollback function, it can cause the powertrain to produce a reduced amount of torque to allow for a controlled rollback of the vehicle down an incline.

Advantageously, the methods, systems, and devices disclosed herein can monitor and regulate the torque produced by the powertrain of an EV based on factors, such as current environmental conditions and capabilities of the powertrain. As a result, the motor of the EV may be prevented from entering the stalled state, which may prevent damages to various components of the EV.

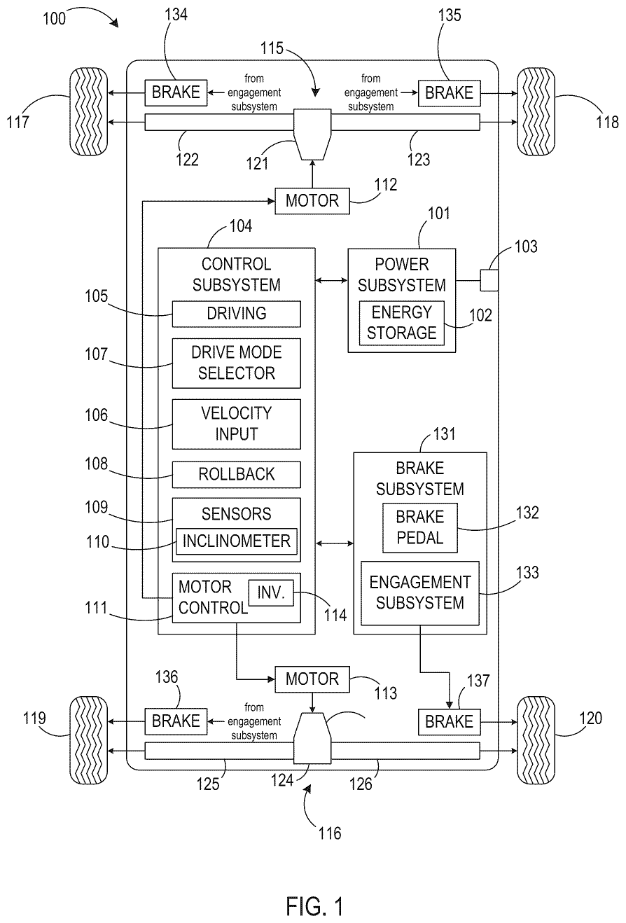

Now turning to the figures, FIG. 1 illustrates a block diagram of an electric vehicle (EV) 100 according to one or more aspects of this disclosure. The EV 100 includes a power subsystem 101 configured to store and deliver power throughout the EV 100. An energy storage 102 such as a plurality of rechargeable battery cells stores charging energy supplied through a charge port 103 via a charging station (not shown). The power subsystem 101 is coupled to a control subsystem 104 for powering a plurality of functions for propelling or driving the EV 100. The control subsystem 104 may be representative of one or more processors, processing systems or devices, or processing circuitry configured to execute control algorithms related to powertrain functionality, such as torque control or motor control. Examples of the processors include a general processing unit, a central processing unit (CPU), a microcontroller, a programmable logic controller, a digital signal processor, an application-specific integrated circuit (ASIC), field-programmable logic devices, and the like, as well as any combination or variation thereof.

A driving protocol 105 is configured to control driving the EV 100 in a desired direction of travel (e.g., forward or reverse) as controlled by a driver or user engaging a torque input 106 such as an accelerator pedal. References to the accelerator pedal 106 or to a driver's interaction with the accelerator pedal 106 will be understood to apply to any torque input engageable by the driver and should not be considered to be limited only to an accelerator pedal.

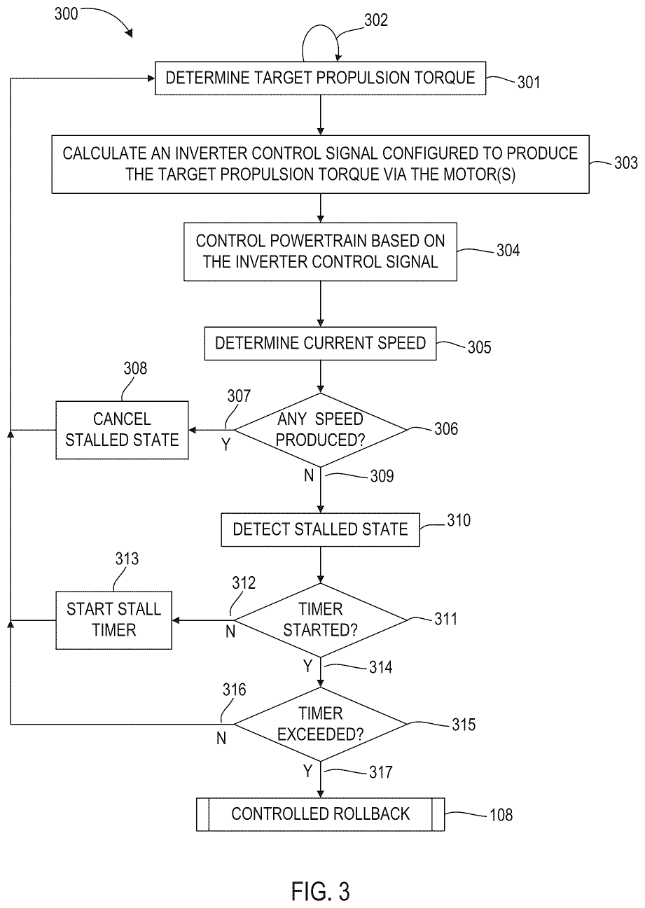

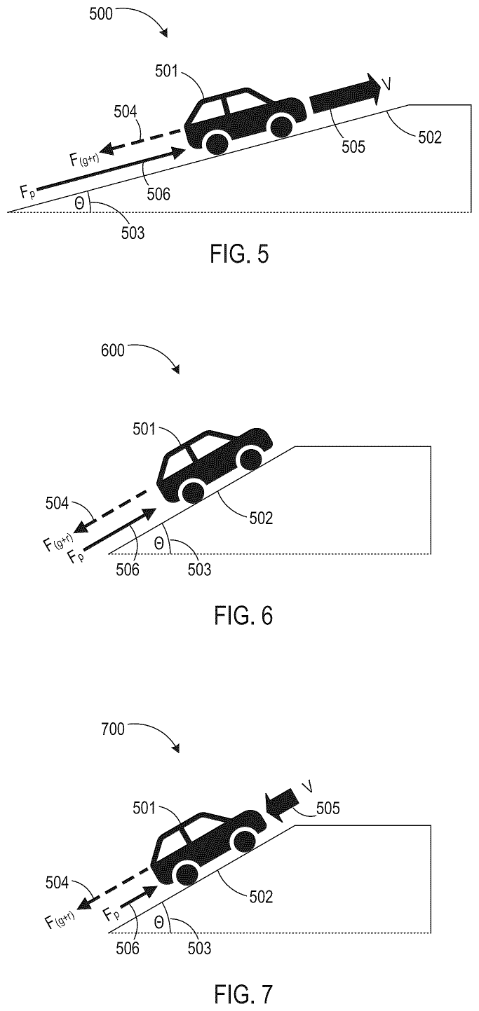

The direction of travel is selected by a drive mode selector 107 that provides standard mode selections to the user such as park, reverse, neutral, and drive. Driving modes include drive and reverse while non-driving modes include park and neutral. Additional selections may be presented based on alternative traction control methods in an example. A method of controlling the EV 100 in a driving mode is discussed with respect to FIG. 3. A vehicle controlled rollback protocol 108 is configured, as described herein, to control the EV 100 in a scenario including motor stall on an incline while the driving mode of the EV 100 is selected. Control of the EV 100 based on the controlled rollback protocol 108 is described in FIGS. 5-10.

A plurality of sensors 109 is included in the control subsystem 104 to sense various aspects of propulsion control based on user interaction or based on automatic systems as described herein. The sensors 109 may include an inclinometer 110.

A drive motor control subsystem 111 is configured to control one or more drive motors 112, 113 to generate torques capable of propelling the EV 100 in the desired drive direction. For example, the drive motor control subsystem 111 includes one or more voltage inverters 114 for each drive motor, and the power provided to the drive motors from the voltage inverters causes the drive motors to generate rotational torque that is applied to the wheels. In one embodiment, for example, the voltage inverters are three-phase DC-to-AC voltage inverters. The drive direction may be in a forward direction in response to the drive mode selected by the drive mode selector 107 and maybe in a reverse direction in response to the reverse mode selected by the drive mode selector 107. The voltage inverters 114, together with the drive motors 112, 113 may be referenced as part of a powertrain of the EV 100.

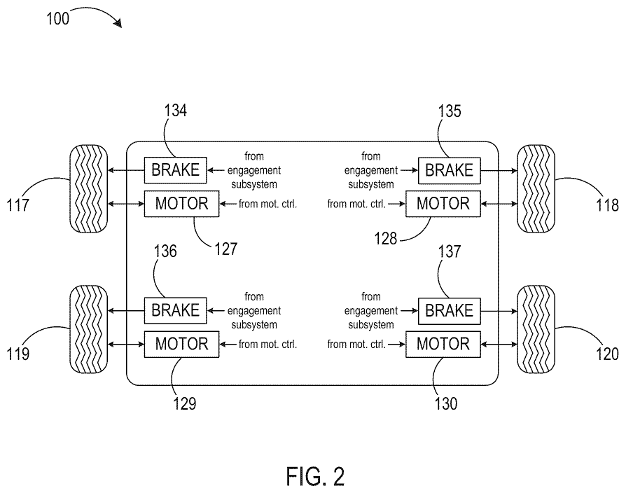

As illustrated in FIG. 1, the EV 100 includes the pair of drive motors 112, 113 coupled to respective axle assemblies 115, 116 for driving wheels 117-120. The axle assembly 115 includes a differential 121, coupled to a pair of axles 122, 123. Axle 122 is coupled to drive wheel 117, and axle 123 is coupled to drive wheel 118. The axle assembly 116 includes a differential 124 coupled to a pair of axles 125, 126 that are coupled to respective wheels 119, 120. While two drive motors 112, 113 and axle assemblies 115, 116 are shown, the EV 100 may have only one drive motor with its associated axle assembly (e.g., drive motor 112 and axle assembly 115). For example, in an alternative embodiment as shown in FIG. 2, the EV 100 may not include either axle assembly 115, 116 and may instead include an individual drive motor 127-130 coupled a respective wheel 117-120.

Returning to FIG. 1, a brake subsystem 131 includes a user input such as a brake pedal 132 configured to drive a braking engagement subsystem 133 coupled to brakes 134-137 at each respective wheel 117-120. The braking engagement subsystem 133 may be, in some embodiments, a hydraulic system, a pneumatic system, an electrical system, or the like. Thus, in the embodiment illustrated, the brake subsystem 131 includes manually engaged brakes that are not controlled through electronic means. However, embodiments of this disclosure contemplate the use of electronically engaged brakes. Rather than engaging a hydraulic subsystem, a brake pedal of an electronically engaged brake subsystem may rely on a sensor sensing the position of the brake pedal and controlling electronic brakes coupled to the wheels based on the sensed pedal position.

FIG. 3 illustrates a driving method 300 with controlled rollback for an electric vehicle (e.g., EV 100) in accordance with an embodiment. The driving mode method 300 may be executed and controlled via the control subsystem 104, for example. Referring to FIGS. 1 and 3, method 300 begins at step 301 with identifying or detecting a target propulsion torque from a driver torque input. The target propulsion torque may be acquired from various manual or automatic torque input sources. In one embodiment, a position of the accelerator pedal 106 as it is engaged by a driver is sensed (e.g., via a sensor of the plurality of sensors 109). The pedal position may be correlated with a desired torque in a lookup table, for example. In another embodiment, a cruise control system having a target speed set by the user is configured to set a target torque configured to control the vehicle to achieve the target speed based on road, incline, and traffic conditions. An automatic parking protocol, in another embodiment, may control a target torque during forward and reverse operations as the vehicle attempts to position itself in a parking space. Other methods of manual or automatic setting of the target torque are also considered within the scope of this disclosure.

Should no target propulsion torque be received or determined from the driver torque input, the state of step 301 may be maintained (at 302) until a target propulsion torque is determined or until an external process acts to cancel the method 300. For example, a change in the drive mode selector 107 from a driving mode selection to a non-driving mode selection will cancel the driving method 300.

An inverter control signal is calculated at step 303 that is configured to control the implemented drive motors 112, 113, 127-130 to generate the target propulsion torque. At step 304, the EV powertrain is controlled based on the calculated inverter control signal to produce the target propulsion torque. That is, the calculated inverter control signal is applied to the voltage inverters 114 to control the drive motors to produce the target propulsion torque. For example, the inverter control signal may be a pulse-width modulation signal configured to control a plurality of switches in each voltage inverter 114 to invert a DC voltage from the power subsystem 101 into an AC three-phase signal configured to flow through three-phase windings in a stator of a respective drive motor to generate the target propulsion torque in a rotor coupled to a drive wheel. The target propulsion torque is generated in the drive motor(s) in a rotational direction based on the driving direction (e.g. forward or reverse) selected by the drive mode selector 107. When transferred to the drive wheel(s), the applied torque tends to drive the same rotational direction in the drive wheel(s). In an embodiment where a force of the applied torque is greater than opposing forces, the EV 100 is propelled in the driving direction. However, the opposing forces may be equal to or greater than the force of the applied torque. When the opposing forces are equal to the force of the applied torque equal, a stalled condition can exist. When the opposing forces are greater than the force of the applied torque, the vehicle can be propelled in an opposite direction to the driving direction. Thus, even though the applied torque may be tending to move the driving wheel(s) in a forward direction, for example, the opposite forces may cause the driving wheel(s) to move in the reverse direction.

An actual or current traveling speed of the vehicle is determined at step 305. The current speed may be determined, for example, by a wheel rotation sensor or a ground speed sensor of the plurality of sensors 109 as a feedback provided to the control subsystem 104.

The driving method 300 includes detection of motor stall, which can cause component damage (e.g., to the voltage inverters 114 or to the drive motors 112, 113, 127-130) if the stall condition persists in an extreme condition for a sufficient period of time. In addition, the method 300 provides a solution to removing the stall condition. Thus, method 300 includes identifying, at step 306, whether any actual or current speed is being generated via application of the target propulsion torque to the drive wheel(s). If any speed is being produced (at 307) via the drive motors and drive wheel(s), no stall state is detected. The method 300 may take the opportunity to cancel or clear, at step 308, any stalled state flag or setting that may have been set in a previous iteration. For example, one or more preceding iterations may have determined a motor stall condition based on a stopping of the vehicle while driving torque was applied to the drive wheel(s) for a time period less than a stall time threshold. However, due to a subsequent movement of the vehicle prior to an expiration of the stall time threshold, the stalled state no longer exists. As such, it may be beneficial to cancel any related actions or parameters associated with a stalled state such as a flag indicating that the vehicle is stalled and a timer initially set to determine a length of time since the flag was last set.

However, if no speed (at 309) is being produced as determined at step 306, a stalled state is detected at step 310, and the stalled state flag or setting may be set as a result. If the stalled state flag is already set, the flag may be left in the set state at step 310.

In a stalled state or condition, the voltage inverters 114 and drive motors 112, 113, 127-130 may be subject to a level of energy that can be adverse thereto if extended over a period of time. For example, when not experiencing a stalled state, the voltage inverters 114 may supply energy to the drive motors through each of the three phase lines. However, if a drive motor becomes stalled, any of the phase lines of the voltage inverter coupled to the stalled drive motor and attempting to transmit power to the stalled drive motor remain active during the attempt. As such, the active phase lines may be subjected to a high amount of current for a sustained period of time while attempting to induce a large torque through the motor. If the large current persists for a certain time period, detrimental effects to the inverter may be experienced. The stalled drive motor may also experience detrimental effects through application of the current through one of its phase windings. As stated, however, there is a certain time limit (e.g., a high-current time limit) that either of the voltage inverter 114 or the stalled drive motor may withstand a high current/power in a single phase before becoming adversely affected. Beyond this time, the affected component is likely to begin suffering adverse effects. This time limit is generally particular to each voltage inverter or drive motor. However, a stall timer may be chosen to be of less duration than the time limit of the most vulnerable component. As discussed below, expiration of the stall timer may allow for appropriate actions to be taken to reduce or completely avoid detrimental effects experienced by the voltage inverters or drive motors.

In this regard, the driving method 300 checks, at step 311, to see whether a stall timer has been started. If the stall timer has not been started (at 312), the stall timer is started at step 313. The process then returns to step 301 to begin another iteration of the method 300 as described above. However, if the stall timer has been started (at 314), a check is made at step 315 to determine whether the stall timer has exceeded a stall time threshold. The stall time threshold is based on the stall time limit discussed above and is of a duration shorter than the high-current time limit of the most vulnerable component. If the stall timer is not exceeded (at 316), the process returns to step 301 to begin another iteration of the method 300 as described above. In the event that the stall timer is exceeded (at 317) during the check at brake 135, the vehicle controlled rollback protocol 108 may be implemented to control the stalled drive motor out of its stalled state.

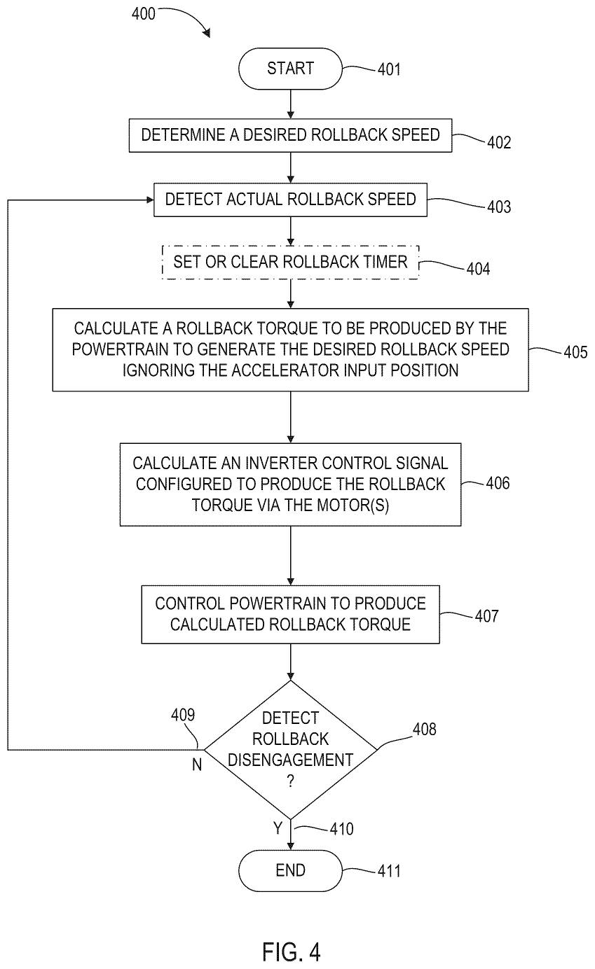

FIG. 4 illustrates a series of steps for performing a controlled rollback control algorithm 400 according to the vehicle controlled rollback protocol 108 of FIGS. 1 and 3 in accordance with an embodiment. Algorithm 400 is a method configured to remove a stalled state of any voltage inverter or drive motor experiencing a stall. The stalled state may be experienced through a drive motor attempting to apply a target torque that fails to cause vehicle movement.

FIG. 5 illustrates an example operating environment 500 including an electric vehicle (EV) 501 (e.g., EV 100 of FIG. 1) operating on an inclined surface 502 in accordance with an embodiment. As illustrated, EV 501 may be traveling up (e.g., to the right in the illustration shown in FIG. 5) the inclined surface 502 at a traveling speed. Inclined surface 502 may be representative of an inclined street, a hill, a ramp, or the like. Inclined surface 502 may have a pitch including a number of degrees greater than zero degrees but less than ninety degrees, as represented by angle 503. While EV 501 is positioned and operating on inclined surface 502, the angle 503 of inclined surface 502 may influence the power requirements of the powertrain to overcome environmental conditions (e.g., force 504) and move EV 501 at velocity 505 up incline 502. In the example shown in FIG. 5, application of the driving method 300 has yielded a target propulsion torque sufficient to allow the powertrain of the EV 501 to produce a propulsion force 506 that overcomes the environmental conditions 504 such that a vehicle speed 505 is experienced. In this manner, none of the voltage inverters 114 nor drive motors 112, 113, 127-130 experience a stalled state or condition.

FIG. 6 illustrates an example operating environment 600 in which the EV 501 is on the inclined surface 502 at a greater angle 503. As shown, the powertrain force 506 applied to the drive motors via inverter control signal calculated at step 303 of the driving method 300 based on the target propulsion torque is matched by the force of the environmental conditions 504. As a result, no speed or velocity in a forward drive direction is produced by the EV 501. In this condition, a high target propulsion torque attempting to cause the EV 501 to travel up the inclined surface 502 merely maintains the vehicle in a suspended state where the vehicle moves neither up nor down the inclined surface 502. As such, an extended period of attempting to produce the high target propulsion torque can produce a stalled state in the powertrain components of the EV 501.

Referring back to FIG. 4, the controlled rollback control algorithm 400 starts at step 401 and continues to determine a desired rollback speed at step 402. The desired rollback speed corresponds with a speed desired for the vehicle (e.g., EV 501 in FIG. 6) to travel in an opposite direction than that indicated by the drive mode selector 107 at a controlled, constant speed. For example, referring to FIG. 6, the opposite direction corresponds to a reverse or downhill direction (e.g., to the left in the illustration shown in FIG. 6). At step 403 an actual rollback speed of the vehicle is detected or measured. The actual rollback speed may be detected as describe above with respect to detecting the actual traveling speed of the vehicle in step 305 of the driving method 300. An optional rollback timer may be set or cleared as shown in phantom at step 404. The rollback timer may be used to end the controlled rollback control algorithm 400 should a rollback timer threshold be exceeded due to a failure to remove the stalled state. Accordingly, if no rollback speed is determined at step 403, the rollback timer may be set. If the rollback timer is already set, it may be left running. However, if there is some movement in the rollback direction, a stalled state is not experienced, and the rollback timer may be cleared.

Both the determined desired rollback speed (step 402) and the actual rollback speed (step 403) are used at step 405 to calculate a rollback torque to be produced that generates the desired rollback speed. The rollback torque value is calculated ignoring any input from the driver torque input setting the target propulsion torque (see step 301). The driver torque input is ignored since the target propulsion torque set by the driver torque input is causing the stalled condition. In one example, the accelerator pedal 106 may be engaged to its end engagement limit (e.g., “floored”) by the driver in attempting to continue or begin travel up the inclined surface 502 (FIG. 6). While the accelerator pedal 106 remains thus engaged, it is desirable to address the stalled condition without consideration of the accelerator pedal 106 as the driver may not release the accelerator pedal 106 sufficiently to remove the stalled condition through such pedal disengagement. The rollback torque value is further calculated based on the determined desired rollback speed (step 402) and the actual rollback speed (step 403) to target a constant desired rollback speed (402). In this manner, the rollback torque value is modified to cause the actual rollback speed to be constant. The calculation of the rollback torque can also be based on a level of incline as measured by the inclinometer 110.

An inverter control signal is calculated at step 406 that is configured to control the implemented drive motors 112, 113, 127-130 to generate the rollback torque. At step 407, the EV powertrain is controlled based on the calculated inverter control signal to produce the rollback torque. The rollback torque is applied in the drive direction selected by the drive mode selector 107. FIG. 7 illustrates an example operating environment 700 in which the EV 501 is on the inclined surface 502 at a same angle 503 as the angle 503 of FIG. 6. As shown, The powertrain force 506 directed uphill and produced via application of the rollback torque to the drive motors at step 406 is smaller than the force of the environmental conditions 504 directed downhill. Thus, the EV 501 is caused to travel in a reverse direction at a velocity 505 targeted by the desired rollback speed (step 402) even though the rollback torque is applied in a rotational direction against the actual drive wheel (and drive motor rotor) rotational direction. In an example, the desired rollback speed is less than five miles per hour and may be less than two miles per hour and may be less than one miles per hour. This desired rollback speed is held constant through the detection of the velocity 505 and a comparison of the velocity 505 with the desired rollback speed in the calculation or modification of the rollback torque in step 405. As the drive motor(s) and drive wheel(s) are caused to rotate in the reverse direction, energy supplied to the motor(s) from the corresponding voltage inverter(s) 114 flows through the three-phases rather than only a single phase in the stalled condition. Thus, though the drive wheel(s) is caused to rotate in an angular direction contrary to the applied rollback torque from the drive motor(s), the stalled condition of the voltage inverter(s) and/or the drive motor(s) is eliminated.

Referring again to FIG. 4, the algorithm 400 detects, at step 408, whether any disengagement condition of the controlled rollback control algorithm 400 exists. Absent any disengagement condition, the algorithm 400 is configured to return (at 409) to step 403 to continue iterations of the steps 403-408. Disengagement conditions may be set based on, for example, an input from the brake subsystem 131 (e.g., driver engagement with the brake pedal 132), a change in the drive mode via the drive mode selector 107, or by an obstacle in the rollback path detected by an obstacle detection subsystem (not shown). The disengagement condition may also be based on a duration of time of the rollback timer (404). For example, a rollback timer runtime greater than the rollback timer threshold can trigger a disengagement condition to discontinue the controlled rollback control algorithm 400. The rollback timer threshold may be set to the same time duration as the stall time threshold discussed above.

In one embodiment, a disengagement condition is not set based on a release of the driver torque input 106 or based on the driver torque input 106 setting a target propulsion torque of zero. Accordingly, a driver disengagement of an accelerator pedal 106, for example, does not cause the controlled rollback control algorithm 400 to be canceled. Instead, an engagement of the brake pedal 132 by the driver is one way to cancel the algorithm 400 through driver interaction. In response to detecting a rollback disengagement condition (at 410), the algorithm 400 ends at 411.

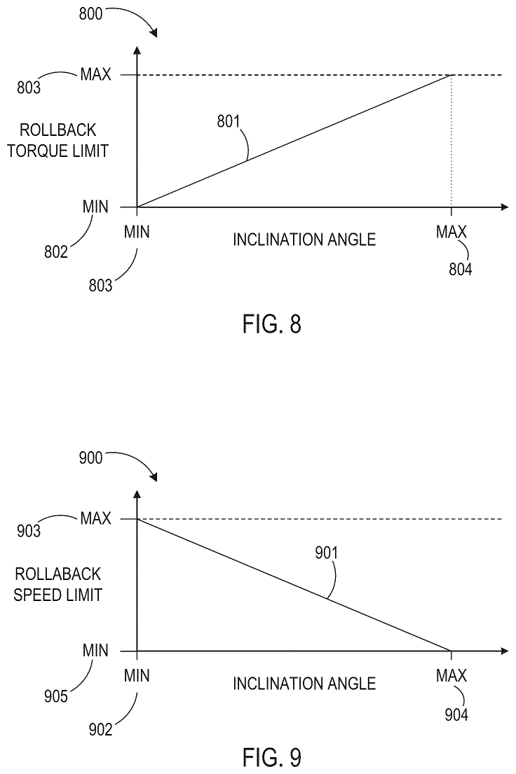

FIG. 8 illustrates a plot 800 showing a relationship between a rollback torque limit and an inclination angle in accordance with an embodiment. Referring to FIGS. 4-8, an inclination angle 801 determined by sensing the inclination 503 of the EV 501 via the inclinometer 110 has a relationship with a maximum value calculatable for the rollback torque in, for example, step 405 of the controlled rollback control algorithm 400. For example, when positioned on a level surface, the amount of rollback torque required to propel the EV 501 in the driving direction at a target rollback speed is not as great as the amount of rollback torque needed to propel the EV 501 at the target rollback speed when the EV 100 is on an inclined surface. Thus, a limit to the rollback torque calculatable via the step 405 may be at a minimum value 802 in response to detecting a minimum inclination angle 803 (e.g., a minimum inclination angle sufficient to cause rollback of the EV 501) via the inclinometer 110.

A maximum amount of available rollback torque 804 may be available, however, should the EV 501 be on a surface of maximum inclination 805. The amount of maximum inclination angle may be determined based on a number of factors such as an expected amount of power needed from the power subsystem 101 to produce the target rollback speed. Other factors may also determine the maximum inclination angle 805. Measured values higher than the maximum inclination angle 805, the control subsystem 104 may terminate any usage of the controlled rollback control algorithm 400 to produce a rollback condition as described herein. In one embodiment, the absence of any detectable inclination angle 801 during the controlled rollback control algorithm 400 may result in the maximum value 804 of the rollback torque being available for use.

In addition to determining a limit to the rollback torque calculatable in the controlled rollback control algorithm 400, the inclinometer 110 may also be used to limit the target rollback speed. FIG. 9 illustrates a plot 900 showing a relationship between a rollback speed and an inclination angle in accordance with an embodiment. Referring to FIGS. 4-7 and 9, an inclination angle 901 determined by sensing the inclination of the EV 501 via the inclinometer 110 has a relationship with a target or desired rollback speed available for determination in, for example, step 402 of the controlled rollback control algorithm 400. When traveling in the rollback direction via the rollback condition according to the controlled rollback control algorithm 400, it may be desirable to lower the target rollback speed at higher inclines 503 to reduce the rollback speed. As such, at a minimum level surface minimum value 902 the EV 501 may be allowed to travel at the maximum rollback speed limit 903. Inversely, a measured incline at the maximum inclination 904 will limit the target rollback speed to a minimum value 905. For example, the calculated rollback torque may be modified to cause the rollback speed to be no greater than the maximum creeping speed limit 903 determined based on the inclination angle 901.

By including measurements of the inclination angle 503 during calculation of the rollback torque, a response time may be improved in arriving at a constant rollback speed. For example, in response to a steeper incline 503, a higher initial rollback torque value may be initially used in the beginning iterations of the controlled rollback control algorithm 400. In addition, a faster time to achieve the target rollback speed may improve the time in removing the stall condition due to a lower rollback torque allowing a lower opposing force value (e.g., 504) to act against the rollback torque.

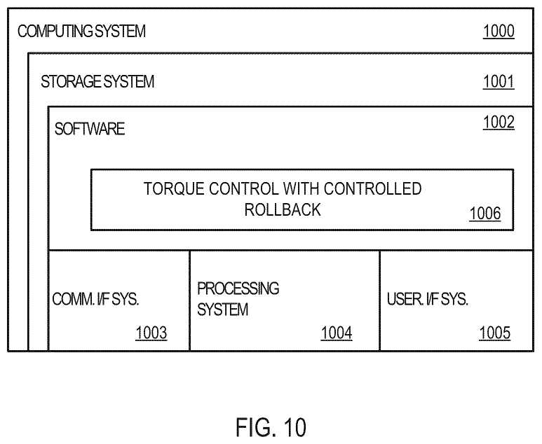

FIG. 10 illustrates a computing system 1000 to perform torque control with controlled rollback according to an implementation of the present technology. Computing system 1000 is representative of any system or collection of systems with which the various operational architectures, processes, scenarios, and sequences disclosed herein for performing torque control with controlled rollback processes may be employed. Computing system 1000 may be implemented as a single apparatus, system, or device or may be implemented in a distributed manner as multiple apparatuses, systems, or devices. Computing system 1000 includes, but is not limited to, storage system 1001, software 1002, communication interface system 1003, processing system 1004, and user interface system 1005 (optional). Processing system 1004 is operatively coupled with storage system 1001, communication interface system 1003, and user interface system 1005. Computing system 1000 may be representative of a cloud computing device, distributed computing device, or the like.

Processing system 1004 loads and executes software 1002 from storage system 1001. Software 1002 includes and implements torque control with controlled rollback 1006, which is representative of any of the methods 300, 400 described herein. When executed by processing system 1004 to control vehicle rollback, software 1002 directs processing system 1004 to operate as described herein for at least the various processes, operational scenarios, and sequences discussed in the foregoing implementations. Computing system 1000 may optionally include additional devices, features, or functionality not discussed for purposes of brevity.

Referring still to FIG. 10, processing system 1004 may comprise a micro-processor and other circuitry that retrieves and executes software 1002 from storage system 1001. Processing system 1004 may be implemented within a single processing device but may also be distributed across multiple processing devices or sub-systems that cooperate in executing program instructions. Examples of processing system 1004 include general purpose central processing units, graphical processing units, application specific processors, and logic devices, as well as any other type of processing device, combinations, or variations thereof.

Storage system 1001 may comprise any computer readable storage media readable by processing system 1004 and capable of storing software 1002. Storage system 1001 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1001 may also include computer readable communication media over which at least some of software 1002 may be communicated internally or externally. Storage system 1001 may be implemented as a single storage device but may also be implemented across multiple storage devices or sub-systems co-located or distributed relative to each other. Storage system 1001 may comprise additional elements, such as a controller capable of communicating with processing system 1004 or possibly other systems.

Software 1002 (including torque control with controlled rollback 1006) may be implemented in program instructions and among other functions may, when executed by processing system 1004, direct processing system 1004 to operate as described with respect to the various operational scenarios, sequences, and processes illustrated herein. For example, software 1002 may include program instructions for implementing torque control with controlled rollback processes as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1002 may include additional processes, programs, or components, such as operating system software, virtualization software, or other application software. Software 1002 may also comprise firmware or some other form of machine-readable processing instructions executable by processing system 1004.

In general, software 1002 may, when loaded into processing system 1004 and executed, transform a suitable apparatus, system, or device (of which computing system 1000 is representative) overall from a general-purpose computing system into a special-purpose computing system customized to provide torque control with controlled rollback process performance as described herein. Indeed, encoding software 1002 on storage system 1001 may transform the physical structure of storage system 1001. The specific transformation of the physical structure may depend on various factors in different implementations of this description. Examples of such factors may include, but are not limited to, the technology used to implement the storage media of storage system 1001 and whether the computer-storage media are characterized as primary or secondary storage, as well as other factors.

For example, if the computer readable storage media are implemented as semiconductor-based memory, software 1002 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1003 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication interface system 1003 may communicate with sensors and input devices such as the plurality of sensors 109 of FIG. 1. Additionally, it is observable that the ambient temperature affects battery overpotential. Accordingly, communication interface system 1003 may also communicate with one or more temperature sensors (not shown) to compare observed changes with the ambient temperature. In one embodiment, temperature calibration curves may be included and consulted to help determine what behavior a given battery should exhibit at a given cycle and temperature.

Communication between computing system 1000 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The aforementioned communication networks and protocols are well known and need not be discussed at length here.

While some examples provided herein are described in the context of an electric vehicle, system, subsystem, circuit, or environment, the systems, components, and methods described herein are not limited to such embodiments and may apply to a variety of other processes, systems, applications, devices, and the like. Aspects of the present invention may be embodied as a system, method, device, and other configurable systems.

Unless the context clearly requires otherwise, throughout the description and the claims, the words “comprise,” “comprising,” and the like are inclusive meaning “including, but not limited to.” In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A. A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the invention is not to be seen as limited by the foregoing description but is only limited by the scope of the appended claims.

What is claimed is:

1. An electric vehicle (EV) comprising:
a vehicle wheel;
a drive subsystem comprising a drive motor coupled with the vehicle wheel; and
a control subsystem coupled to the drive subsystem and comprising a driver torque input configured to set a target propulsion torque;
wherein the control subsystem is configured to:
control the drive motor to apply the target propulsion torque to the vehicle wheel;
determine a stalled condition of the drive subsystem during the application of the target propulsion torque; and
in response to determining the stalled condition,
calculate a rollback torque, the rollback torque comprising a lower torque value than a torque value of the target propulsion torque; and
control the drive motor to cancel the application of the target propulsion torque and to apply the rollback torque to the vehicle wheel, the rollback torque configured to allow the EV to travel down an incline at a rollback speed.

2. The EV of claim 1, wherein the driver torque input comprises an accelerator pedal configured to be engaged by a driver.

3. The EV of claim 1, wherein the control subsystem further comprises a drive mode selector configured to set a drive direction;
wherein the control subsystem is further configured to:
control the drive motor to apply the target propulsion torque in a first rotational direction;
control the drive motor to apply the rollback torque in the first rotational direction; and
wherein a rotational direction of the vehicle wheel during the vehicle travel down the incline is in a second rotational direction opposite the first rotational direction.

4. The EV of claim 1, wherein the control subsystem is further configured to:
measure the rollback speed; and
modify the rollback torque based on the measured rollback speed to control the travel down the incline at a constant rollback speed.

5. The EV of claim 1, wherein the control subsystem is further configured to ignore the target propulsion torque set by the driver torque input in calculating the rollback torque.

6. The EV of claim 1, wherein the control subsystem is further configured to:
detect a rollback disengagement condition; and
cancel the application of the rollback torque in response to detecting the rollback disengagement condition.

7. The EV of claim 6, wherein the rollback disengagement condition comprises one of an engagement of a brake subsystem, a change in a drive direction via a drive mode selector, and a detection of an obstacle in a path of the EV.

8. The EV of claim 6, the driver torque input is configured to set the target propulsion torque to a zero value; and
wherein the control subsystem is further configured to maintain application of the rollback torque without consideration of the driver torque input setting the target propulsion torque to the zero value.

9. The EV of claim 1, wherein the control subsystem further comprises an inclinometer; and
wherein the control subsystem is further configured to:
detect an amount of the incline; and
calculate the rollback torque based on the detected amount of the incline.

10. A method of propelling an electric vehicle (EV) comprising a driving wheel, a drive subsystem comprising a drive motor, and a control subsystem, the method comprising:
applying a driving torque in a first rotational direction to the driving wheel via the drive motor sufficient to cause the EV to travel in a drive direction in response to a propulsion input;
sensing a stalled condition in the drive motor;
calculating a rollback torque having a torque value lower than a torque value of the driving torque; and
subsequent to sensing the stalled condition:
ceasing application of the driving torque; and
applying the rollback torque in the first rotational direction to the driving wheel via the drive motor sufficient to cause the EV to travel in a rollback direction opposite to the drive direction.

11. The method of claim 10, wherein sensing the stalled condition comprises sensing no speed in the EV in response to applying the driving torque.

12. The method of claim 10 further comprising:
measuring a rollback speed of the EV in response to travelling in the rollback direction; and
controlling the rollback torque to cause the EV to travel in the rollback direction at a constant rollback speed.

13. The method of claim 10 further comprising:
detecting a rollback disengagement condition; and
ceasing application of the rollback torque in response to detecting the rollback disengagement condition.

14. The method of claim 13 further comprising:
measuring a rollback speed of the EV in response to application of the rollback torque; and
starting a rollback timer in response to measuring a rollback speed of zero; and
wherein detecting the rollback disengagement condition comprises sensing an expiration of the rollback timer after a rollback timer threshold.

15. The method of claim 10 further comprising:
sensing an inclination angle via an inclinometer; and
adjusting a maximum rollback torque value base on the inclination angle;
wherein calculating the rollback torque comprises calculating a torque value of the rollback torque no greater than the maximum rollback torque value.

16. A computing apparatus comprising:
one or more computer-readable storage media; and
program instructions stored on the one or more computer-readable storage media executable by a processing device to direct the processing device to:
detect a stalled state in a drive motor coupled to a drive wheel of an electric vehicle (EV), the drive motor applying a driving torque to the drive wheel;
remove application of the driving torque to the drive wheel in response to detecting the stalled state;
calculate a rollback torque having a torque value lower than a torque value of the driving torque; and
apply the rollback torque to the drive wheel in a first rotational direction while the drive wheel rotates in a second rotational direction opposite the first rotational direction.

17. The computing apparatus of claim 16, wherein the program instructions further direct the processing device to:
cause the drive motor to apply the driving torque to the drive wheel in the first rotational direction;
detect no vehicle propulsion in response to application of the driving torque to the drive wheel; and
detect the stalled state based on the detection of no vehicle propulsion.

18. The computing apparatus of claim 16, wherein the program instructions further direct the processing device to:
detect a rollback speed of the drive wheel in response to the rollback torque, and
modify the rollback torque to cause the rollback speed to be constant.

19. The computing apparatus of claim 18, wherein the program instructions further direct the processing device to:
measure an incline of the EV; and
set a maximum value of the rollback torque based on the measured incline.

20. The computing apparatus of claim 19, wherein the program instructions further direct the processing device to:
determine a maximum rollback speed based on the measured incline; and
modify the rollback torque to cause the rollback speed to be no greater than the maximum rollback speed.
